(19) United States
(12) Patent Application Publication
(10) Pub. No.: US 2020/0023891 A1
(43) Pub. Date: Jan. 23, 2020

(54) SYSTEM AND METHOD OF PREDICTIVE FAULT MITIGATION FOR ELECTRIC POWER STEERING SYSTEM IN A VEHICLE

(71) Applicant: GM Global Technology Operations LLC, Detroit, MI (US)

(72) Inventors: Wen-Chiao Lin, Rochester Hills, MI (US); Xinyu Du, Oakland Township, MI (US); Brian N. Siskoy, Berkley, MI (US)

(73) Assignee: GM Global Technology Operations LLC, Detroit, MI (US)

(21) Appl. No.: 16/037,669

(22) Filed: Jul. 17, 2018

(51) Int. Cl. B62D 5/04; G05D 1/00; G05D 1/02; G07C 5/00; G07C 5/08

(52) U.S. Cl. CPC B62D 5/0484; B62D 5/0487; G05D 1/0061; G07C 5/0816; G05D 1/0088; G07C 5/006; G05D 1/021

(57) ABSTRACT

A method of controlling a vehicle having an electric power steering system includes generating a plurality of possible routes. Each of the plurality of possible routes that require a steering torque that is within an available torque range is identified as a system compliant route. Each of the plurality of possible routes that require an angular position of an electric motor of the electric power steering system at all time indices throughout that route that are within an available motor position range are also identified as a system compliant route. One of the identified system compliant routes is selected based on at least one selection criteria, and designated as an active route. The electric power steering system is then controlled to maneuver the vehicle along the active route. The electric power steering system is monitored as the vehicle moves along the active route to identify degradation of its capabilities.

### INTRODUCTION

The disclosure generally relates to a method of controlling a vehicle having an electric power steering system.

Some vehicles are equipped with an electric power steering system that may be controlled by a computing device to provide semi-autonomous and/or fully autonomous vehicle steering. Electric power steering systems use an electric motor to provide a torque to a shaft to assist an operator in turning the steering wheels of the vehicle. The electric power steering system may be controlled by a computing device to automatically apply torque to the steering system to enable semi-autonomous and/or fully autonomous vehicle operations.

Certain factors may reduce the functionality of the electric power steering system. For example, a low battery voltage, an increase in steering friction and/or steering resistance, or an increase in electrical resistance in an electrical circuit of the electric power steering system, may reduce or limit the capabilities of the electric power steering system. When the vehicle is being operated in a semi-autonomous or fully autonomous condition, in which the computing device is actively controlling the electric power steering system with minimal or no input from a human operator, then the computing device should control the electric power steering within its available capabilities.

### SUMMARY

A method of controlling a vehicle having an electric power steering system is provided. The method includes a computing device generating a plurality of possible routes. The possible routes may include traversing the vehicle between a current location and a destination, or executing one or more maneuvers in an upcoming time interval. The computing device may also identify each of the plurality of possible routes that require a variable steering torque to execute that possible route that is within an available torque range at all time indices throughout that possible route as a system compliant route. It should appreciated that the steering torque, and possibly the available torque range, are constantly changing throughout each possible route. The computing device further identifies each of the plurality of possible routes that require a variable angular position of an electric motor of the electric power steering system at all time indices throughout the route being considered, which is within an available motor position range at all time indices throughout that possible route, as a system compliant route. It should be appreciated that the available motor position range may change throughout each possible route. The computing device then selects one of the identified system compliant routes, based on at least one selection criteria, and designates the selected one of the system compliant routes as an active route. The computing device may then control the electric power steering system of the vehicle to maneuver the vehicle along the active route.

In one aspect of the method of controlling the vehicle, the computing device calculates an available torque from the windings of the electric motor. Each winding may include a three phase winding that, in combination with an output shaft and the other windings, may be considered a three phase brushless DC motor. For example, in an electric motor having a first winding and a second winding, the computing device calculates an available torque from the first winding of the electric motor of the electric power steering system, and calculates an available torque from the second winding of the electric motor of the electric power steering system. The computing device may then sum the available torque from the first winding and the available torque from the second winding to define a total torque limitation. The available torque range may be defined as a range equal to or greater than a negative value of the total torque limitation, and equal to or less than a positive value of the total torque limitation. It should be appreciated that the negative value of the total torque limitation may be considered a steering input in one of a clockwise or counterclockwise direction, and that the positive value of the total torque limitation may be considered a steering input in the other of the clockwise and counterclockwise direction.

In another aspect of the method of controlling the vehicle, the computing device may calculate the available torque from the first winding and calculate the available torque from the second winding by solving a torque equation for the first winding and the second winding respectively. Each winding of the three phase electric motor may be modeled as an equivalent DC motor. The torque equation is:

$${T}_{avail} = {K}_{t} \frac{{V}_{B} - {V}_{Cmin}}{{R}_{C}} .$$

Within the torque equation, Tₐᵥₐᵢₗ is the available torque, Kₜ is a motor constant of the electric motor of the electric power steering system, V_{B} is a voltage from a energy source, e.g., a battery, powering the electric power steering system, V_{Cmin} is a minimum circuit voltage for the electric power steering system, below which the electric power steering system would stop operating and reset, and R_{C} is a resistance in a circuit between the energy source and the electric power steering system. The torque equation is described in greater detail in U.S. patent application Ser. No. 15/840,270, which is assigned to the Applicant of this application. Estimation of the resistance R_{C} in the circuit between the energy source and the electric power steering system is described in greater detail in U.S. patent application Ser. No. 15/333,216, which is assigned to the Applicant of this application.

In another embodiment, the computing device may calculate the available torque from the first winding and calculate the available torque from the second winding by solving a power equation for the first winding and the second winding respectively. The power equation is:

$${V}_{B} \frac{{V}_{B} - {V}_{Cmin}}{{R}_{C}} - {( \frac{{V}_{B} - {V}_{Cmin}}{{R}_{C}} )}^{2} {R}_{C} = {( \frac{{T}_{Avail}}{{K}_{t}} )}^{2} {R}_{M} + {T}_{Avail} ω ( k ) + ɛ .$$

Within the power equation, V_{B} is a voltage from a energy source, e.g., a battery, powering the electric power steering system, V_{Cmin} is a minimum circuit voltage the electric power steering system, below which the electric power steering system would stop operating and reset, R_{C} is a resistance in a circuit between the energy source and the electric power steering system, Kₜ is a motor constant of the electric motor of the electric power steering system, Tₐᵥₐᵢₗ is the available torque at a time index k, R_{M} is a resistance of the electric motor of the electric power steering system, ω is the rotational speed of the electric motor, k is the time index, and ε is the electric losses in the electric power steering system, which may be neglected when the electric motor is operating at a high efficiency or can be estimated when the efficiency of the electric motor is known.

In another aspect of the method of controlling the vehicle, the computing device may calculate the steering torque for each of the plurality of possible routes from a steering system dynamic equation. The steering system dynamic equation is:

Steering Torque=\dot{ω}J+C_{fr} sign(ω)+SAT+Bω.

Within the steering system dynamic equation, sign(ω) is a rotational speed of an electric motor of the electric power steering system, wherein the “sign” is defined as a positive or negative value of the rotational speed of (ω), \dot{ω} is a first derivative of the rotational speed of the electric motor, J is an amount of inertia in the electric power steering system, C_{fr} is a friction coefficient of the electric power steering system, SAT is a self-aligning torque value of the electric power steering system, and B is a damping value of the electric power steering system. The values of the variables of the steering system dynamic equation are considered after any gear reduction of the electric motor. Detection and/or calculation of the friction coefficient of the electric power steering system, C_{fr}, is described in greater detail in U.S. Pat. No. 8,634,986, which is assigned to the Applicant of this application. Calculation of the self-aligning torque value of the electric power steering system, SAT, is described in greater detail in U.S. Pat. No. 8,634,986, which is assigned to the Applicant of this application. A low voltage V_{B} from the energy source, an increase in the resistance R_{C} in the circuit between the energy source and the electric power steering system, and/or an increase in the friction coefficient of the electric power steering system C_{fr}, may cause the electric power steering system to experience low input voltages, which may potentially interrupt autonomous steering operations of the vehicle.

In another aspect of the method of controlling the vehicle, the computing device may identify each of the plurality of possible routes that require a variable steering torque required to execute that possible route that is within the available torque range at all time indices throughout that route by comparing the steering torque for each of the plurality of possible routes calculated from the steering system dynamic equation to a range between a negative value of the total torque limitation and a positive value of the total torque limitation. As noted above, the negative value of the total torque limitation may be considered a steering input in one of a clockwise or counterclockwise direction, and that the positive value of the total torque limitation may be considered a steering input in the other of the clockwise and counterclockwise direction. The computing device may determine that the required steering torque of at least one of the possible routes is within the available torque range if it is determined to be equal to or greater than the negative value of the total torque limitation and equal to or less than the positive value of the total torque limitation.

In another aspect of the method of controlling the vehicle, the computing device may determine if the angular position of the electric motor at all time indices throughout each respective route is within the available motor position range at all time indices throughout that route by solving a first steering system position equation, a second steering position equation, and a third steering system position equation. The first steering system position equation, the second steering position equation, and the third steering position equation may be solved to provide a range for the available angular positions of the electric motor. The first steering system position equation provides an angular position of the electric motor at the time index (k+1), given that the angular position of the electric motor at the time index (k) is greater than the angular position of the electric motor at an immediately previous time index (k−1). The first steering system position equation is:

$$θ ( k ) ( 2 - \frac{B Δ t}{J} ) + θ ( k - 1 ) ( \frac{B Δ t}{J} - 1 ) + \frac{- {T}_{limit} Δ {t}^{2} - {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J} .$$

Within the first steering system position equation, θ is the angular position of the electric motor, k is the incremental time index, B is a damping value of the electric power steering system, Δt is a discrete period of time, J is an amount of inertia in the electric power steering system, Tₗᵢₘᵢₜ is a total torque limitation of the electric power steering system, C_{fr} is a friction coefficient of the electric motor, and SAT is a self-aligning torque value of the electric power steering system. The values of the variables of the first steering system position equation are considered after any gear reduction of the electric motor.

The second steering system position equation provides an angular position of the electric motor at the time index (k+1), given that the angular position of the electric motor at the time index (k) is less than the angular position of the electric motor at the immediately previous time index (k−1). The second steering system position equation is:

$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} + {C}_{fr} Δ {t}^{2} - SAT Δ {t}^{2}}{J} .$$

Within the second steering system position equation, θ is the angular position of the electric motor, k is the incremental time index, B is the damping value of the electric power steering system, Δt is the discrete period of time, J is the amount of inertia in the electric power steering system, Tₗᵢₘᵢₜ is the total torque limitation of the electric power steering system, C_{fr} is the friction coefficient of the electric motor, and SAT is the self-aligning torque value of the electric power steering system. The values of the variables of the second steering system position equation are considered after any gear reduction of the electric motor.

The third steering system position equation provides an angular position of the electric motor at the time index (k+1), given that the angular position of the electric motor at the time index (k) is equal to the angular position of the electric motor at the immediately previous time index (k−1). The third steering system position equation is:

$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J} .$$

Within the third steering system position equation, θ is the angular position of the electric motor, k is the incremental time index, B is the damping value of the electric power steering system, Δt is the discrete period of time, J is the amount of inertia in the electric power steering system, Tₗᵢₘᵢₜ is the total torque limitation of the electric power steering system, C_{fr} is the friction coefficient of the electric motor, and SAT is the self-aligning torque value of the electric power steering system. The values of the variables of the third steering system position equation are considered after any gear reduction of the electric motor.

In one aspect of the method of controlling the vehicle, the at least one selection criteria that the computing device uses to select the active route may include, but is not limited to, at least one of an estimated fuel economy and/or usage for each system compliant route, a route distance for each system compliant route, a route drive time for each system compliant route, and a preferred road type encountered on each system compliant route.

In another aspect of the method of controlling the vehicle, the computing device may issue a notification requesting vehicle maintenance when none of the plurality of possible routes is identified as the system compliant route. Additionally, when none of the plurality of possible routes is identified as the system compliant route, the computing device may automatically park the vehicle if an operator is not present to manually maneuver the vehicle.

In another aspect of the method of controlling the vehicle, once the active route has been designated, the computing device may set a counter for each respective winding of the electric motor of the electric power steering system to zero. For example, in an electric motor having a first winding and a second winding, the computing device may set a first winding counter to zero, and may set a second winding counter to zero. Additionally, the computing device may also set a system level fault counter to zero. The computing device may then determine or calculate a current torque from the first winding of the electric motor, and determine or calculate a current torque from the second winding of the electric motor, as the vehicle is maneuvered along the active route. The computing device increments the first winding counter by a value of one when the current torque output from the first winding is within a pre-defined margin of the torque limit calculated for the first winding. The computing device increments the second winding counter by a value of one when the current torque output from the second winding is within a pre-defined margin of the torque limit calculated for the second winding. The computing device may then compare the first winding counter to a torque counter threshold to determine if the first winding counter is equal to or less than the torque counter threshold, or if the first winding counter is greater than the torque counter threshold. Similarly, the computing device may compare the second winding counter to the torque counter threshold to determine if the second winding counter is equal to or less than the torque counter threshold, or if the second winding counter is greater than the torque counter threshold. When the first winding counter or the second winding counter is greater than the torque counter threshold, the computing device may then issue a notification requesting vehicle maintenance for weak or low voltage at the energy source, e.g., a weak battery, or for increased electrical resistance in the electric power steering system.

In another aspect of the method of controlling the vehicle, the computing device may determine a current angular position of the electric motor as the vehicle is maneuvered along the active route. The computing device increments the system level fault counter by a value of one when the current angular position of the electric motor is within a pre-defined position margin of a position limit of the electric power steering system at the time index. The position limit of the electric power steering system may be defined by the first steering system position equation, the second steering position equation, and the third steering system position equation, described above. The computing device may then compare the system level fault counter to a system level fault counter threshold to determine if the system level fault counter is equal to or less than the system level fault counter threshold, or if the system level fault counter is greater than the system level fault counter threshold. When the system level fault counter is greater than the system level fault counter threshold, the computing device may issue a notification requesting vehicle maintenance for an increase in friction or resistance of the mechanical components of the steering system, an increase in resistance in the motor power circuits, or a weak power source, e.g., a weak battery.

Accordingly, the method described above enables the computing device to determine if a possible route of the vehicle is within the current capabilities of the electric power steering system, and select the active route from those possible routes that are within the capabilities of the electric power steering system, i.e., the system compliant routes. Additionally, the method described above enables the computing device to identify a degradation in the electric power steering system that may degrade steering ability over time, while the vehicle is moving along the active route. The results calculated from the first steering system position equation, the second steering system position equation, and the third steering system position equation may be communicated to a path planning module of the computing device, and used to plan future routes “on the fly”, based on the limitations of the electric power steering system established by the results of these equations.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic diagram of an electric power steering system of a vehicle.

FIG. 2 is a flow chart representing a method of selecting an active route for a vehicle.

FIG. 3 is a flow chart representing a method of identifying a fault in an electric power steering system of the vehicle while maneuvering along the active route.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

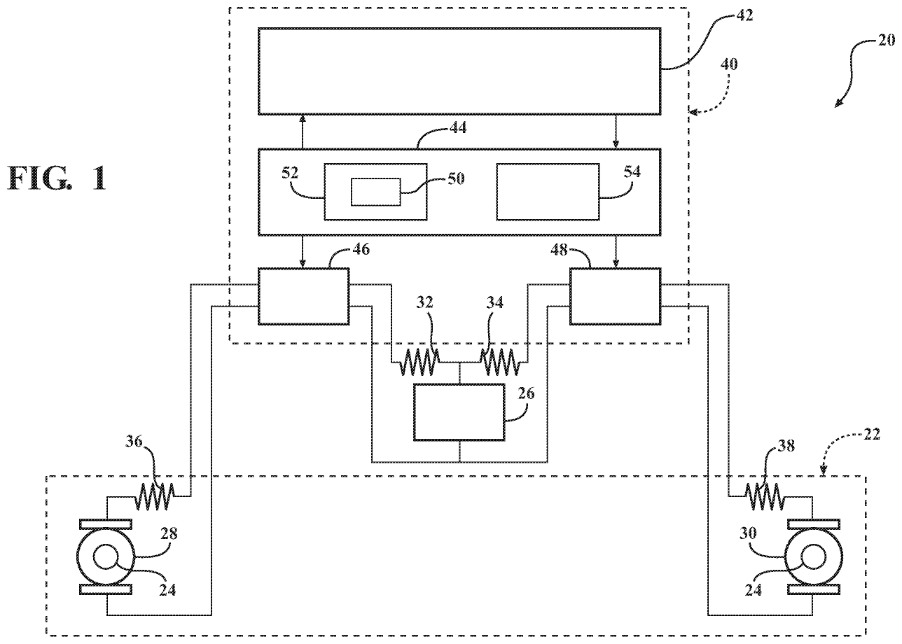

Referring to the FIGS., wherein like numerals indicate like parts throughout the several views, an electric power steering system is generally shown at 20 in FIG. 1. The electric power steering system 20 may be configured in a suitable manner understood by those skilled in the art. Referring to FIG. 1, the electric power steering system 20 may include, for example, an electric motor 22 that is operable to apply torque to a shaft 24. The shaft 24 is connected to a steering system (not shown) of the vehicle. Rotation of the shaft 24 operates the steering system as is understood in the art. The details of the steering system are not pertinent to the teachings of this disclosure, and are therefore not described in detail herein.

Referring to FIG. 1, the electric motor 22 receives power from an energy source 26, such as but not limited to a battery. In the exemplary embodiment shown in FIG. 1 and described herein, the electric motor 22 includes a first winding 28 and a separate second winding 30. Both the first winding 28 and the second winding 30 of the electric motor 22 are coupled to and operable to move the shaft 24. Although the exemplary embodiment described herein refers to the electric motor 22 having the first winding 28 and the second winding 30, it should be appreciated that the teachings provided herein may be applied to systems having a motor with one or more windings. Each winding may include a three phase winding that, in combination with the shaft 24 and the other windings, may be considered a three phase brushless DC motor. The first winding 28 and the second winding 30 are independently operable and controllable to each apply torque to the shaft 24. In the exemplary embodiment shown in FIG. 1 and described herein, each of the first winding 28 and the second winding 30 receive power from the energy source 26. In other embodiments, the electric power steering assembly includes multiple energy sources 26, such that the first winding 28 and the second winding 30 each receive power from a respective dedicated energy source 26. The specific type and configuration of the energy source 26 is not pertinent to the teachings of this disclosure, are understood by those skilled in the art, and are therefore not described in detail herein.

The electric power steering system 20 includes a first system resistance 32 and a second system resistance 34. The first system resistance 32 is the electrical resistance in the circuit between the energy source 26 and the first winding 28 of the electric motor 22. The second system resistance 34 is the electrical resistance in the circuit between the energy source 26 and the second winding 30 of the electric motor 22. The electric motor 22 includes a first motor resistance 36 and a second motor resistance 38. The first motor resistance 36 is the electrical resistance in the electric motor 22 for operating the first winding 28, and the second motor resistance 38 is the electrical resistance in the electric motor 22 for operating the second winding 30.

The electric power steering system 20, including the first winding 28 and the second winding 30 of the exemplary embodiment described herein, are controlled by a computing device 40. The computing device 40 may alternatively be referred to as a controller, a vehicle controller, a control module, a computer, an autonomous driving system controller, etc. The computing device 40 may include one or more different devices, and is used herein to generically include the different devices used to control the operation of the different components of the electric power steering system 20, as well as execute a method of controlling the electric power steering system 20 described in greater detail below. For example, referring to FIG. 1, the computing device 40, as used herein, includes a path planning module 42, a supervisory controller 44, a first control unit 46, and a second control unit 48. The path planning module 42 may calculate different possible routes for the vehicle. The supervisory controller 44 may implement a steering control algorithm 50, described in greater detail below, for controlling the electric power steering system 20. The first control unit 46 and the second control unit 48 may be controlled by the supervisory controller 44, and may receive control signals therefrom. The first control unit 46 controls operation of the first winding 28 of the electric motor 22, and the second control unit 48 controls operation of the second winding 30 of the electric motor 22. It should be appreciated that the computing device 40 may include more than or fewer than the exemplary devices shown in FIG. 1 and described herein, and that the computing device 40 should not be limited to the specific architecture shown in FIG. 1 and described herein.

The computing device 40 is operable to control the operation of the electric power steering system 20. The computing device 40 may include a computer and/or a processor, and include software, hardware, memory, algorithms, connections, sensors, etc., for managing and controlling the operation of the electric power steering system 20. As such, a method of controlling a vehicle having an electric power steering system 20, described in greater detail below, may be embodied as a program or algorithm operable on the computing device 40. It should be appreciated that the computing device 40 may include a device capable of analyzing data from various sensors, comparing data, making the decisions required to control the operation of the electric power steering system 20, and executing the required tasks for controlling the operation of the electric power steering system 20 and execute the method described herein.

The computing device 40 includes a tangible non-transitory memory 52 having computer executable instructions recorded thereon, including the steering control algorithm 50. The computing device 40 further includes a processor 54 that is operable to execute the steering control algorithm 50 to determine an active route to maneuver the vehicle along, as well as monitor the status of the electric power steering system 20 to ensure that the electric power steering system 20 is operating properly and capable of completing the active route once initiated.

The computing device 40 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, required input/output (I/O) circuitry, I/O devices, and communication interfaces, as well as signal conditioning and buffer electronics.

The computer-readable memory may include a non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

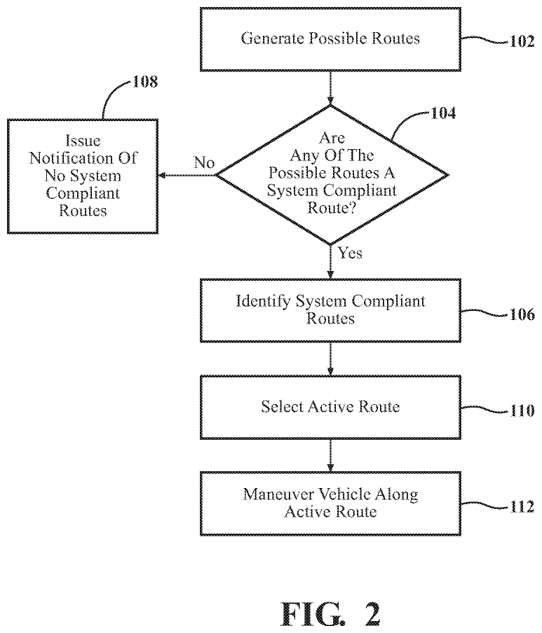

As noted above, the processor 54 of the computing device 40 executes the steering control algorithm 50 to execute the method of controlling the vehicle, and more particularly, a method of controlling the electric power steering system 20 of the vehicle. Referring to FIG. 2, the method includes generating a plurality of possible routes. The step of generating the possible routes is generally indicated by box 102 in FIG. 2. The possible routes may include traversing the vehicle between a current location and a destination, or executing one or more maneuvers in an upcoming time interval. The possible routes include the most likely desirable routes between the current location of the vehicle and the destination for the vehicle, or the most likely or desirable maneuvers in the upcoming time interval. The possible routes may be generated by the computing device 40 in a suitable manner, such as understood by those skilled in the art. For example, the computing device 40 may use a GPS location of the vehicle and of the destination, along with a map saved in the memory of the computing device 40, to generate the possible routes that the vehicle may travel between the current location and the destination. The possible routes may include a single route, or multiple routes. The specific manner in which the computing device 40 generates the possible routes is not pertinent to the teachings of this disclosure, and is therefore not described in detail herein.

The computing device then determines if at least one of the possible routes are system compliant routes. The step of determining if at least one of the possible routes are system compliant routes is generally indicated by box 104 in FIG. 2. The computing device 40 identifies each of the plurality of possible routes that require a steering torque at all time indices (k−1, k, k+1, k+2, . . . , k+n) throughout that route that is within an available torque range at all time indices through that route, or that require an angular position of the electric motor 22 of the electric power steering system 20 at all time indices throughout that route that are within an available motor position range at all time indices throughout that route, as a system compliant route. The step of identifying the system compliant routes is generally indicated by box 106 in FIG. 2. As used herein, the term system compliant route includes the possible routes that the electric steering system is capable of executing. The system compliant routes include the possible routes that require the respective steering torque from the electric motor 22 to complete the respective possible route to be within the available torque range, or that require the respective angular position of the electric motor 22 at all time indices throughout that route to be within the available motor position range. The system compliant routes may include a number of the possible routes. For example, in some embodiments, none of the possible routes may be identified as a system compliant route. In other embodiments, the possible routes may be identified as a system compliant routes. In yet other embodiments, a portion of the possible routes may be identified as a system compliant route.

As noted above, the computing device 40 identifies each of the possible routes that require the steering torque to execute the respective possible route be within the available torque range of the electric power steering system 20, as a system compliant route. In order to do so, the computing device 40 calculates the available torque range of the electric power steering system 20. The computing device 40 calculates the available torque range by first calculating an available torque from each winding of the electric motor 22, e.g., the first winding 28 and the second winding 30 of the exemplary embodiment described herein, and then sums the available torque from each winding of the electric motor 22. In other words, the computing device 40 calculates an available torque from the first winding 28 of the electric motor 22 of the electric power steering system 20, and also calculates an available torque from the second winding 30 of the electric motor 22 of the electric power steering system 20. The computing device 40 then sums, i.e., adds, the available torque from the first winding 28 and the available torque from the second winding 30 to define a total torque limitation. The available torque range is a range having a lower limit equal to or greater than a negative value of the total torque limitation, and an upper limit equal to or less than a positive value of the total torque limitation. It should be appreciated that the negative value of the total torque limitation may be considered a steering input in one of a clockwise or counterclockwise direction, and that the positive value of the total torque limitation may be considered a steering input in the other of the clockwise and counterclockwise direction.

The available torque from the first winding 28 and the available torque from the second winding 30 may be calculated respectively by solving a torque equation (Eq. 1). Each winding of the three phase electric motor 22 may be modeled as an equivalent DC motor. The torque equation (Eq. 1) is defined below as:

$${T}_{avail} = {K}_{t} \frac{{V}_{B} - {V}_{Cmin}}{{R}_{C}} . \qquad Eq . 1$$

Within the torque equation, Tₐᵥₐᵢₗ is the available torque, Kₜ is a motor constant of the electric motor 22 of the electric power steering system 20, V_{B} is a voltage from a energy source 26, e.g., a battery, powering the electric power steering system 20, V_{Cmin} is a minimum circuit voltage for the electric power steering system 20, below which the electric power steering system 20 would stop operating and reset, and R_{C} is a resistance in a circuit between the energy source 26 and the electric power steering system 20. The torque equation is described in greater detail in U.S. patent application Ser. No. 15/840,270, which is assigned to the Applicant of this application. Estimation of the resistance R_{C} in the circuit between the energy source 26 and the electric power steering system 20 is described in greater detail in U.S. patent application Ser. No. 15/333,216, which is assigned to the Applicant of this application. It should be appreciated that the computing device 40 solves the torque equation for each winding of the electric motor 22. For example, in the exemplary embodiment described herein, the computing device 40 will solve the torque equation twice, once for the first winding 28 to calculate the available torque from the first winding 28, and once for the second winding 30 to calculate the available torque from the second winding 30, thereby providing a torque value for each winding of the electric motor 22. These individual torque values for each winding are then summed together to define the total torque limitation of the electric motor 22. As noted above, the available torque range is the range equal to or greater than the negative value of the total torque limitation and equal to or less than the positive value of the total torque limitation.

In another embodiment, the computing device 40 may calculate the available torque from the first winding 28 and calculate the available torque from the second winding 30 respectively by solving a power equation (Eq. 2) for the first winding 28 and the second winding 30 respectively. The power equation (Eq. 2) is defined below as:

$${V}_{B} \frac{{V}_{B} - {V}_{Cmin}}{{R}_{C}} - {( \frac{{V}_{B} - {V}_{Cmin}}{{R}_{C}} )}^{2} {R}_{C} = {( \frac{{T}_{Avail}}{{K}_{t}} )}^{2} {R}_{M} + {T}_{Avail} ω ( k ) + ɛ . \qquad Eq . 2$$

Within the power equation, V_{B} is a voltage from a energy source 26, e.g., a battery, powering the electric power steering system 20, V_{Cmin} is a minimum circuit voltage the electric power steering system 20, below which the electric power steering system 20 would stop operating and reset, R_{C} is a resistance in a circuit between the energy source 26 and the electric power steering system 20, Kₜ is a motor constant of the electric motor 22 of the electric power steering system 20, Tₐᵥₐᵢₗ is the available torque at a time index k, R_{M} is a resistance of the electric motor 22 of the electric power steering system 20, ω is the rotational speed of the electric motor 22, k is the time index, and ε is the electric losses in the electric power steering system 20, which may be neglected when the electric motor is operating at a high efficiency or can be estimated when the efficiency of the electric motor is known.

The computing device 40 further calculates the steering torque for each of the plurality of possible routes from a steering system dynamic equation, which is then compared to the available torque range. The steering torque for each respective one of the possible routes may be calculated from a steering system dynamic equation (Eq. 3). The steering system dynamic equation (Eq. 3) is defined below as:

Steering Torque=\dot{ω}J+C_{fr} sign(ω)+SAT+Bω Eq. 3.

Within the steering system dynamic equation, sign(ω) is a rotational speed of the electric motor 22 of the electric power steering system 20, wherein the “sign” is defined as a positive or negative value of the rotational speed of (ω), \dot{ω} is a first derivative of the rotational speed of the electric motor 22, J is an amount of inertia in the electric power steering system 20, C_{fr} is a friction coefficient of the electric motor 22, SAT is a self-aligning torque value of the electric power steering system 20, and B is a damping value of the electric power steering system 20. The values of the variables of the steering system dynamic equation (Eq. 3) are considered after any gear reduction of the electric motor 22. Detection and/or calculation of the friction coefficient of the electric power steering system 20, C_{fr}, is described in greater detail in U.S. Pat. No. 8,634,986, which is assigned to the Applicant of this application. Calculation of the self-aligning torque value of the electric power steering system 20, SAT, is described in greater detail in U.S. Pat. No. 8,634,986, which is assigned to the Applicant of this application.

The step of identifying each of the plurality of possible routes that require that the steering torque is within the available torque range includes determining if the steering torque along each of the plurality of possible routes calculated from the steering system dynamic equation is equal to or greater than a negative value of the total torque limitation and equal to or less than a positive value of the total torque limitation. If the computing device 40 determines that the steering torque for a respective possible route is less than the negative value of the total torque limitation, or is greater than the positive value of the total torque limitation, then the computing device 40 does not identify that respective possible route as a system compliant route, because that respective possible route is not within the available torque range. However, if the computing device 40 determines that the steering torque for a respective possible route is equal to or greater than the negative value of the total torque limitation and equal to or less than the positive value of the total torque limitation, then the computing device 40 does identify that respective possible route as a system compliant route, because that respective possible route is within the available torque range. The computing device 40 compares the steering torque for each respective possible route to the available torque range to determine if that respective possible route is within the available torque range and is therefore a system compliant route.

As described above, each of the possible routes may be identified as a system compliant route if the steering torque along that respective possible route is within the available torque range. In addition, as noted above, each of the possible routes may be identified as a system compliant route if the angular position of the electric motor 22 at all time indices in that route are within the available motor position range. The computing device 40 may determine if the angular position of the electric motor 22 at all time indices throughout that route are within the available motor position range for each of the plurality of possible routes by solving a first steering system position equation (Eq. 4), a second steering position equation (Eq. 5), and a third steering system position equation (Eq. 6), described in detail below.

The first steering system position equation (Eq. 4) provides an angular position of the electric motor 22 at the time index (k+1), given that the angular position of the electric motor 22 at the time index (k) is greater than the angular position of the electric motor 22 at an immediately previous time index (k−1). The first steering system position equation (Eq. 4) is defined below as:

$$θ ( k ) ( 2 - \frac{B Δ t}{J} ) + θ ( k - 1 ) ( \frac{B Δ t}{J} - 1 ) + \frac{- {T}_{limit} Δ {t}^{2} - {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J} . \qquad Eq . 4$$

Within the first steering position equation (Eq. 4), θ is the angular position of the electric motor 22, k is the incremental time index, B is a damping value of the electric power steering system 20, Δt is a discrete period of time, J is an amount of inertia in the electric power steering system 20, Tₗᵢₘᵢₜ is a total torque limitation of the electric power steering system 20, C_{fr} is a friction coefficient of the electric motor 22, and SAT is a self-aligning torque value of the electric power steering system 20. The values of the variables of the first steering system position equation are considered after any gear reduction of the electric motor.

The second steering system position equation (Eq. 5) provides an angular position of the electric motor 22 at the time index (k+1), given that the angular position of the electric motor 22 at the time index (k) is less than the angular position of the electric motor 22 at the immediately previous time index (k−1). The second steering system position equation (Eq. 5) is defined below as:

$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} + {C}_{fr} Δ {t}^{2} - SAT Δ {t}^{2}}{J} . \qquad Eq . 5$$

Within the second steering system position equation (Eq. 5), θ is the angular position of the electric motor 22, k is the incremental time index, B is the damping value of the electric power steering system 20, Δt is the discrete period of time, J is the amount of inertia in the electric power steering system 20, Tₗᵢₘᵢₜ is the total torque limitation of the electric power steering system 20, C_{fr} is the friction coefficient of the electric motor 22, and SAT is the self-aligning torque value of the electric power steering system 20. The values of the variables of the second steering system position equation are considered after any gear reduction of the electric motor.

The third steering system position equation (Eq. 6) provides an angular position of the electric motor 22 at the time index (k+1) that is equal to the angular position of the electric motor 22 at the immediately previous time index (k−1). The third steering system position equation (Eq. 6) is defined below as:

$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J} . \qquad Eq . 6$$

Within the third steering system position equation (Eq. 6), θ is the angular position of the electric motor 22, k is the incremental time index, B is the damping value of the electric power steering system 20, Δt is the discrete period of time, J is the amount of inertia in the electric power steering system 20, Tₗᵢₘᵢₜ is the total torque limitation of the electric power steering system 20, C_{fr} is the friction coefficient of the electric motor 22, and SAT is the self-aligning torque value of the electric power steering system 20. The values of the variables of the third steering system position equation are considered after any gear reduction of the electric motor.

If the angular position of the electric motor 22 for a respective possible route satisfies each of the first steering system position equation (Eq. 4), the second steering system position equation (Eq. 5), and the third steering system position equation (Eq. 6) for all time indices throughout that possible route, then the computing device 40 identifies that respective possible route as a system compliant route. However, if the angular position of the electric motor 22 for a respective possible route fails to satisfy each of the first steering system position equation (Eq. 4), the second steering system position equation (Eq. 5), and the third steering system position equation (Eq. 6) for at least one of the time indices throughout that respective possible route, then the computing device 40 does not identify that respective route as a system compliant route.

If the computing device 40 fails to identify at least one of the possible routes as a system compliant route, i.e., there are no system compliant routes, then the computing device 40 may issue a notification requesting vehicle maintenance. The step of issuing a notification that none of the possible routes are system compliant routes is generally indicated by box 108 in FIG. 2. The computing device 40 may issue the notification in a suitable manner, such as but not limited to flashing a warning light, displaying a message to an occupant of the vehicle, transmitting a communication to a remote location, etc. Additionally, when none of the possible routes are identified as a system compliant route, the computing device 40 may automatically park the vehicle in a suitable location, or transfer control of the vehicle to a human operator.

Once the computing device 40 has identified the system compliant routes, the computing device 40 may then select one of the identified system compliant routes, and designate the selected one of the system compliant routes as an active route. The step of selecting the active route is generally indicated by box 110 in FIG. 2. The computing device 40 may select the active route from the identified system compliant routes based on at least one pre-defined selection criteria. The selection criteria may include, but is not limited to, at least one of an estimated highest fuel economy of the vehicle available from the respective system compliant routes, a shortest respective route distance available from the respective system compliant routes, a shortest route drive time available from the respective system compliant routes, and a preferred road type traversed along the respective system compliant routes. It should be appreciated that the selection of the active route may be based on multiple selection criteria, and that the importance of the different selection criteria may be weighted to favor one criteria over another.

Once the active route has been selected, the computing device 40 may then control the electric power steering system 20 of the vehicle to maneuver the vehicle along the active route. The step of maneuvering the vehicle along the active route is generally indicated by box 112 in FIG. 2. It should be appreciated that the computing device 40 may further control other vehicle systems to move the vehicle along the active route, including but not limited to, a powertrain system, a braking system, a navigation system, etc. The manner in which the computing device 40 controls the electric power steering system 20 to move the vehicle along the active route is understood by those skilled in the art, is not pertinent to the teachings of this disclosure, and is therefore not described in detail herein.

The method described above may be implemented to select the active route, which the electric power steering system 20 is capable of executing. Additional steps may be implemented to monitor the status of the electric power steering system 20 as the vehicle is traveling along the selected active route, and take corrective action if needed.

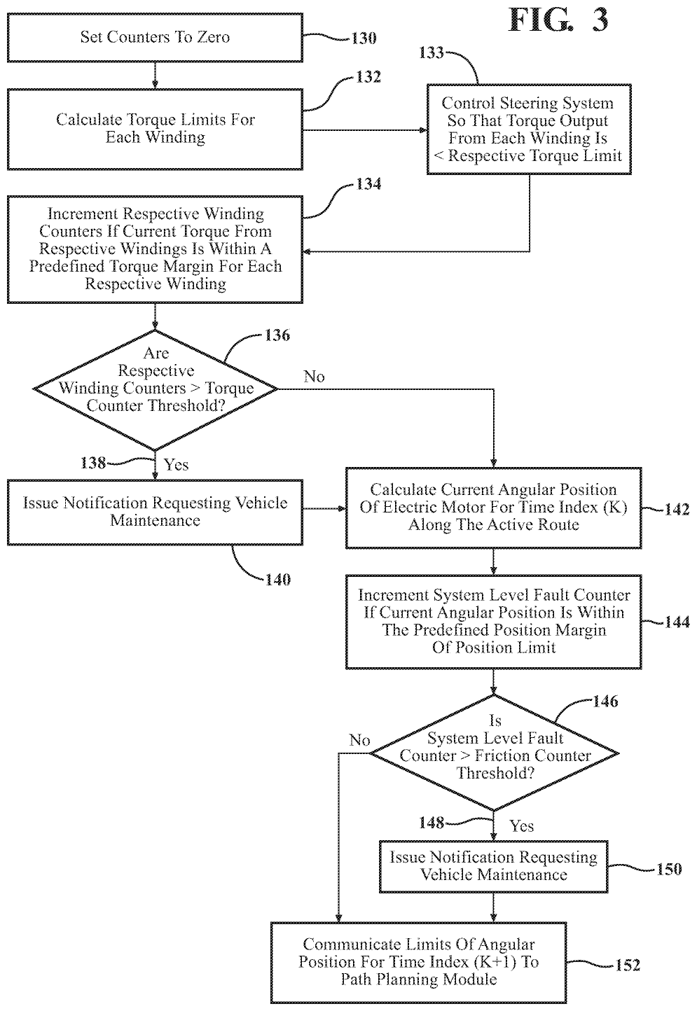

Referring to FIG. 3, when the active route is designated or generated on-the-fly by the path planning module 42, the method may further include the computing device 40 setting a winding counter for each winding of the electric motor 22 to zero. For example, in the exemplary embodiment described herein, in which the electric motor 22 includes the first winding 28 and the second winding 30, the computing device 40 sets a first winding counter to zero, and sets a second winding counter to zero. Additionally, the computing device 40 sets a system level fault counter to zero. The step of setting the winding counters and the system level fault counter to zero is generally indicated by box 130 in FIG. 3. The first winding counter, the second winding counter, and the system level fault counter are counters, i.e., values, stored in the memory 52 of the computing device 40. Each of the first winding counter, the second winding counter, and the system level fault counter may be incremented as described below, to track the condition of the electric power steering system 20. While the exemplary embodiment described herein describes the first winding counter and the second winding counter, it should be appreciated that if the electric motor 22 of the electric power steering system 20 includes more than the exemplary two windings, then the computing device 40 will track a corresponding number of winding counters. For example, if the electric motor 22 is configured to include three windings, then the computing device 40 will store and track three winding counters, i.e., a respective winding counter for each winding of the electric motor 22.

For each incremental time index (k) as the vehicle is maneuvered along the active route, the computing device 40 determines a torque limit for each respective winding of the electric motor. The step of calculating the torque limit for each respective winding of the electric motor is generally indicated by box 132 in FIG. 3. Accordingly, the computing device 40 calculates a torque limit for the first winding 28 of the electric motor 22, and a torque limit for the second winding 30 of the electric motor 22. The torque limit for each respective winding may be calculated, for example, from Equations 1 or 2 described above.

For each incremental time index (k), the computing device 40 then controls the electric power steering system 20 so that the torque output from each winding is less than its respective torque limit calculated in box 132. The step of controlling the electric power steering system 20 is generally indicated by box 133 in FIG. 3. It should be appreciated that the computing device 40 controls the electric power steering system to follow the active route. The active route may include the selected one of the compliant routes, or may alternatively include a route that is being generated on-the-fly.

In order to control the power steering system 20 within the calculated torque limits of the respective windings, the computing device 40 may calculate a current or output torque for each of the windings in a suitable manner. For example, the current or output torque for each of the windings may be calculated from a torque equation T=KI, wherein T is the current torque from a winding, K is a motor constant of an equivalent DC motor, and I is the motor current of the equivalent DC motor. Alternatively, the current or output torque for each of the windings may be measured and/or sensed using one or more sensors and related algorithms. The current or output torque for each winding of the electric motor 22 may be calculated and/or determined in some other manner not specifically described herein.

When the current available torque at a respective time index (k) from the first winding 28 is within a pre-defined torque margin for the first winding 28, the computing device 40 increments the first winding counter by a value of one. The pre-defined torque margin may include a value, factor, percentage or range of a torque limitation for each respective winding. The torque margin establishes a range having a lower end slightly less than the total torque limitation and an upper end equal to the total torque limitation. The torque margin may consider the absolute value of the current torque, or may include a positive range and a negative range for positive torque values and negative torque values respectively. Similarly, when the current available torque at a respective time index (k) from the second winding 30 is within a pre-defined torque margin of the second winding 30, the computing device 40 increments the second winding counter by a value of one. The computing device 40 increments the first winding counter and the second winding counter for each occurrence in which the current available torque at a respective time index (k) from the respective winding is within the pre-defined torque margin of the respective winding. The step of incrementing the winding counters is generally indicated by box 134 in FIG. 3.

The computing device 40 then compares the first winding counter to a torque counter threshold to determine if the first winding counter is equal to or less than the torque counter threshold, or if the first winding counter is greater than the torque counter threshold. Similarly, the computing device 40 compares the second winding counter to the torque counter threshold to determine if the second winding counter is equal to or less than the torque counter threshold, or if the second winding counter is greater than the torque counter threshold. The step of determining if the respective winding counters are greater than the torque counter threshold is generally indicated by box 136 in FIG. 3. When the first winding counter or the second winding counter is greater than the torque counter threshold, generally indicated at 138, the computing device 40 may issue a notification requesting vehicle maintenance for a weak or low voltage from the energy source 26, or an increased electrical resistance in the electric power steering system 20. The step of issuing the notification for vehicle maintenance for low voltage or increased electrical resistance is generally indicated by box 140 in FIG. 3. The computing device 40 may issue the notification in a suitable manner, such as but not limited to flashing a warning light, displaying a message to an occupant of the vehicle, transmitting a communication to a remote location, etc. Additionally, when the first winding counter or the second winding counter is greater than the torque counter threshold, the computing device 40 may control the electric power steering system 20 using a degraded capabilities strategy, automatically park the vehicle in a suitable location, or may transfer control of the vehicle to a human operator.

When the current torque from the electric motor 22 is near the total torque limitation, it is an indication that the electric motor 22 is nearing its torque capacity, and further degradation may prevent the electric motor 22 from being able to provide the required torque for maneuvering the vehicle along the active route. The number of occurrences in which the current torque of one of the windings of the electric motor 22 is within the torque margin is tracked via their respective winding counter to identify which of the windings may be faulty. As the value of each respective winding counter increases, the likelihood of a faulty winding increases. The torque counter threshold is set at a level that indicates a likely fault.

Additionally, the computing device 40 determines a current angular position of the electric motor 22 at the current time index (k) as the vehicle is maneuvered along the active route. The step of calculating the current angular position of the electric motor 22 along the active route is generally indicated by box 142 in FIG. 3. When the current angular position of the electric motor 22 at the current time index (k) is within a pre-defined position margin of a position limit of the electric power steering system 20, the computing device 40 increments the system level fault counter by a value of one. The step of incrementing the system level fault counter is generally indicated by box 144 in FIG. 3. The position limit of the electric power steering system 20 at the time index (k +1) may be defined or calculated using the first steering system position equation (Eq. 4), the second steering position equation (Eq. 5), and the third steering system position equation (Eq. 6) described above. The computing device 40 calculates the position limit of the electric power steering system 20 at the time index (k+1) using information available from the position limits at time index (k). The position margin may include a value, factor, percentage or range of the position limit. The position margin establishes a range having a lower end slightly less than the position limit and an upper end equal to the position limit. The position margin may include a positive range and a negative range for positive position values and negative position values respectively. A positive position value may be associated with either a clockwise steering input or a counterclockwise steering input, whereas a negative position value may be associated with the other of the clockwise steering input and the counterclockwise steering input. When the current angular position of the electric motor 22 at a respective time index (k) is within the pre-defined position margin of the position limit, the computing device 40 increments the system level fault counter by a value of one. The computing device 40 increments the system level fault counter for each occurrence in which the current angular position of the electric motor 22 at a respective time index (k) is within the pre-defined position margin.

The computing device 40 may then compare the system level fault counter to a system level fault counter threshold to determine if the system level fault counter is equal to or less than the system level fault counter threshold, or if the system level fault counter is greater than the system level fault counter threshold. The step of determining if the system level fault counter is greater than the system level fault counter threshold is generally indicated by box 146 in FIG. 3. When the system level fault counter is greater than the system level fault counter threshold, generally indicated at 148, the computing device 40 may issue a notification requesting vehicle maintenance for an increase in friction and/or resistance in the mechanical components of the steering system, an increase in resistance in a motor power circuit, or a weak power source, e.g., a weak battery. The step of issuing a notification for an increase in resistance in the mechanical components of the steering system is generally indicated by box 150 in FIG. 3. The computing device 40 may issue the notification in a suitable manner, such as but not limited to flashing a warning light, displaying a message to an occupant of the vehicle, transmitting a communication to a remote location, etc. Additionally, when the system level fault counter is greater than the system level fault counter threshold, the computing device 40 may control the electric power steering system 20 using the degraded capabilities strategy, automatically park the vehicle in a suitable location, or may transfer control of the vehicle to a human operator.

When the current angular position of the electric motor 22 at the time index (k) is near the position limit, it is an indication that the electric motor 22 is nearing its limit of travel, and further degradation may prevent the electric motor 22 from being able to provide the required movement for maneuvering the vehicle along the active route. The number of occurrences in which the current angular position of the electric motor 22 is within the position margin is tracked via the system level fault counter. As the value of the system level fault counter increases, the likelihood of a fault in the electric power steering system 20 increases. The system level fault counter threshold is set at a level that indicates a likely fault.

In addition, the results calculated from the first steering system position equation (Eq. 4), the second steering system position equation (Eq. 5), and the third steering system position equation (Eq. 6) may be communicated to the path planning module 42 of the computing device 40, and used to plan future routes “on the fly” for the next time interval (k+1), based on the limitations of the electric power steering system 20 established by the results of these steering position equations. By so doing, the path planning module 42 may plan future routes and/or vehicle maneuvers based on the current operating capabilities of the electric power steering system 20. The step of communicating the results calculated from the steering system position equations to the path planning module is generally indicated by box 152 in FIG. 3.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of controlling a vehicle having an electric power steering system, the method comprising:
generating a plurality of possible routes, with a computing device;
identifying each of the plurality of possible routes that require a steering torque that is within an available torque range, or that require an angular position of an electric motor of the electric power steering system at all time indices throughout that route that are within an available motor position range, as a system compliant route, with the computing device;
selecting one of the identified system compliant routes with the computing device, based on at least one selection criteria, and designating the selected one of the system compliant routes as an active route; and
controlling the electric power steering system of the vehicle, with the computing device, to maneuver the vehicle along the active route.

2. The method set forth in claim 1, further comprising calculating an available torque from each winding of the electric motor of the electric power steering system, with the computing device.

3. The method set forth in claim 2, further comprising summing the available torque from each winding of the electric motor to define a total torque limitation, with the computing device.

4. The method set forth in claim 3, wherein the available torque range is a range having a lower limit equal to or greater than a negative value of the total torque limitation and an upper limit equal to or less than a positive value of the total torque limitation.

5. The method set forth in claim 2, wherein calculating the available torque from the windings of the electric motor includes solving a power equation for each winding respectively, wherein the power equation is:
$${V}_{B} \frac{{V}_{B} - {V}_{Cmin}}{{R}_{C}} - {( \frac{{V}_{B} - {V}_{Cmin}}{{R}_{C}} )}^{2} {R}_{C} = {( \frac{{T}_{Avail}}{{K}_{t}} )}^{2} {R}_{M} + {T}_{Avail} ω ( k ) + ɛ$$
wherein, V_{B} is a voltage from a energy source powering the electric power steering system, V_{Cmin} is a minimum circuit voltage the electric power steering system, R_{C} is a resistance in a circuit between the energy source and the electric power steering system, Kₜ is a motor constant of the electric motor of the electric power steering system, Tₐᵥₐᵢₗ is the available torque at a time index k, R_{M} is a resistance of the electric motor of the electric power steering system, w is the rotational speed of the electric motor, k is the time index, and ε is the electric losses in the electric power steering system.

6. The method set forth in claim 3, further comprising calculating the steering torque for each of the plurality of possible routes from a steering system dynamic equation, with the computing device wherein the steering system dynamic equation is:
Steering Torque=\dot{ω}J+C_{fr} sign(ω)+SAT+Bω
wherein, sign(ω) is a rotational speed of an electric motor of the electric power steering system, wherein the “sign” is defined as a positive or negative value of the rotational speed of (ω), \dot{ω} is a first derivative of the rotational speed of the electric motor, J is an amount of inertia in the electric power steering system, C_{fr} is a friction coefficient of the electric power steering system, SAT is a self-aligning torque value of the electric power steering system, and B is a damping value of the electric power steering system.

7. The method set forth in claim 6, wherein identifying each of the plurality of possible routes that require the steering torque that is within the available torque range includes determining if the steering torque for each of the plurality of possible routes calculated from the steering system dynamic equation is equal to or greater than a negative value of the total torque limitation and equal to or less than a positive value of the total torque limitation.

8. The method set forth in claim 1, further comprising determining if the angular position of the electric motor at all time indices throughout a possible route are within the available motor position range includes solving a first steering system position equation, a second steering position equation, and a third steering system position equation, with the computing device;
wherein the first steering system position equation provides an angular position of the electric motor at the time index (k+1), given that the angular position of the electric motor at the time index (k) is greater than the angular position of the electric motor at an immediately previous time index (k−1), wherein the first steering system position equation is:
$$θ ( k ) ( 2 - \frac{B Δ t}{J} ) + θ ( k - 1 ) ( \frac{B Δ t}{J} - 1 ) + \frac{- {T}_{limit} Δ {t}^{2} - {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J}$$
wherein θ is the angular position of the electric motor, k is the incremental time index, B is a damping value of the electric power steering system, Δt is a discrete period of time, J is an amount of inertia in the electric power steering system, Tₗᵢₘᵢₜ is a total torque limitation of the electric power steering system, C_{fr} is a friction coefficient of the electric motor, and SAT is a self-aligning torque value of the electric power steering system;
wherein the second steering system position equation provides an angular position of the electric motor at the time index (k+1), given that the angular position of the electric motor at the time index (k) is less than the angular position of the electric motor at the immediately previous time index (k−1), wherein the second steering system position equation is:
$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} + {C}_{fr} Δ {t}^{2} - SAT Δ {t}^{2}}{J}$$
wherein θ is the angular position of the electric motor, k is the incremental time index, B is the damping value of the electric power steering system, Δt is the discrete period of time, J is the amount of inertia in the electric power steering system, Tₗᵢₘᵢₜ is the total torque limitation of the electric power steering system, C_{fr} is the friction coefficient of the electric motor, and SAT is the self-aligning torque value of the electric power steering system;
wherein the third steering system position equation provides an angular position of the electric motor at the time index (k+1), given that the angular position of the electric motor at the time index (k) is equal to the angular position of the electric motor at the immediately previous time index (k−1), and wherein the third steering system position equation is:
$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J}$$
wherein θ is the angular position of the electric motor, k is the incremental time index, B is the damping value of the electric power steering system, Δt is the discrete period of time, J is the amount of inertia in the electric power steering system, Tₗᵢₘᵢₜ is the total torque limitation of the electric power steering system, C_{fr} is the friction coefficient of the electric motor, and SAT is the self-aligning torque value of the electric power steering system.

9. The method set forth in claim 8, further comprising communicating results from the first steering position equation for time index (k+1), the results from the second steering position equation for time index (k+1), and the results from the third steering position equation for time index (k+1) to a planning module, and planning a future route with the planning module using the results from the first steering position equation for time index (k+1), the results from the second steering position equation for time index (k+1), and the results from the third steering position equation for time index (k+1).

10. The method set forth in claim 1, further comprising at least one of issuing a notification requesting vehicle maintenance, operating the vehicle in a degraded capabilities strategy, automatically parking the vehicle, or transferring control to a human operator, with the computing device, when none of the plurality of possible routes is identified as the system compliant route.

11. The method set forth in claim 3, further comprising setting a first winding counter to zero, setting a second winding counter to zero, and setting a system level fault counter to zero, with the computing device, when the active route is designated.

12. The method set forth in claim 11, further comprising determining a torque limit from the first winding of the electric motor, and a torque limit from the second winding of the electric motor with the computing device, as the vehicle is maneuvered along the active route.

13. The method set forth in claim 12, further comprising incrementing the first winding counter by a value of one, with the computing device, when the current torque from the first winding is within a pre-defined torque margin for the first winding, and incrementing the second winding counter by a value of one when the current torque from the second winding is within a pre-defined torque margin for the second winding.

14. The method set forth in claim 13, further comprising:
comparing the first winding counter to a torque counter threshold, with the computing device to determine if the first winding counter is equal to or less than the torque counter threshold, or if the first winding counter is greater than the torque counter threshold; and
comparing the second winding counter to the torque counter threshold, with the computing device to determine if the second winding counter is equal to or less than the torque counter threshold, or if the second winding counter is greater than the torque counter threshold.

15. The method set forth in claim 14, further comprising issuing a notification requesting vehicle maintenance, with the computing device, when the first winding counter or the second winding counter is greater than the torque counter threshold.

16. The method set forth in claim 11, further comprising determining a current angular position of the electric motor, with the computing device, as the vehicle is maneuvered along the active route.

17. The method set forth in claim 16, further comprising incrementing the system level fault counter by a value of one, with the computing device, when the current angular position of the electric motor is within a pre-defined position margin of a position limit of the electric power steering system at the time index, wherein the position limit of the electric power steering system is defined by a first steering system position equation, a second steering position equation, and a third steering system position equation;
wherein the first steering system position equation provides an angular position of the electric motor at the time index (k+1), given that the angular position of the electric motor at the time index (k) is greater than the angular position of the electric motor at an immediately previous time index (k−1), wherein the first steering system position equation is:
$$θ ( k ) ( 2 - \frac{B Δ t}{J} ) + θ ( k - 1 ) ( \frac{B Δ t}{J} - 1 ) + \frac{- {T}_{limit} Δ {t}^{2} - {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J}$$
wherein θ is the angular position of the electric motor, k is the incremental time index, B is a damping value of the electric power steering system, Δt is a discrete period of time, J is an amount of inertia in the electric power steering system, Tₗᵢₘᵢₜ is the total torque limitation of the electric power steering system, C_{fr} is a friction coefficient of the electric motor, and SAT is a self-aligning torque value of the electric power steering system;
wherein the second steering system position equation provides an angular position of the electric motor at the time index (k+1), given that the angular position of the electric motor at the time index (k) is less than the angular position of the electric motor at the immediately previous time index (k−1), wherein the second steering system position equation is:
$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} + {C}_{fr} Δ {t}^{2} - SAT Δ {t}^{2}}{J}$$
wherein θ is the angular position of the electric motor, k is the incremental time index, B is the damping value of the electric power steering system, Δt is the discrete period of time, J is the amount of inertia in the electric power steering system, Tₗᵢₘᵢₜ is the total torque limitation of the electric power steering system, C_{fr} is the friction coefficient of the electric motor, and SAT is the self-aligning torque value of the electric power steering system; and
wherein the third steering system position equation provides an angular position of the electric motor at the time index (k+1), given that the angular position of the electric motor at the time index (k) is equal to the angular position of the electric motor at the immediately previous time index (k−1), and wherein the third steering system position equation is:
$$θ ( k ) ( 2 - \frac{B Δ t}{J} ) + θ ( k - 1 ) ( \frac{B Δ t}{J} - 1 ) + \frac{- {T}_{limit} Δ {t}^{2} + {C}_{fr} Δ {t}^{2} - SAT Δ {t}^{2}}{J} \leq θ ( k + 1 ) \leq θ ( k ) ( 2 - \frac{B Δ t}{J} ) + θ ( k - 1 ) ( \frac{B Δ t}{J} - 1 ) + \frac{{T}_{limit} Δ {t}^{2} - {C}_{fr} Δ {t}^{2} - SAT Δ {t}^{2}}{J}$$
wherein θ is the angular position of the electric motor, k is the incremental time index, B is the damping value of the electric power steering system, Δt is the discrete period of time, J is the amount of inertia in the electric power steering system, Tₗᵢₘᵢₜ is the total torque limitation of the electric power steering system, C_{fr} is the friction coefficient of the electric motor, and SAT is the self-aligning torque value of the electric power steering system.

18. The method set forth in claim 17, further comprising comparing the system level fault counter to a system level fault counter threshold, with the computing device, to determine if the system level fault counter is equal to or less than the system level fault counter threshold, or if the system level fault counter is greater than the system level fault counter threshold.

19. The method set forth in claim 18, further comprising at least one of issuing a notification requesting vehicle maintenance, operating the vehicle in a degraded capabilities strategy, automatically parking the vehicle, or transferring control to a human operator, with the computing device, when the system level fault counter is greater than the system level fault counter threshold.

20. A vehicle comprising:
an electric power steering system operable to control a steering system of the vehicle;
a computing device having a processor and a memory having a steering control algorithm saved thereon, wherein the processor is operable to execute the steering control algorithm to:
generate a plurality of possible routes;
identify each of the plurality of possible routes that require a steering torque that is within an available torque range, or that require an angular position of an electric motor of the electric power steering system at all time indices throughout that route that are within an available motor position range, as a system compliant route;
at least one of issue a notification requesting vehicle maintenance, operate the vehicle in a degraded capabilities strategy, automatically park the vehicle, or transfer control to a human operator, when none of the plurality of possible routes is identified as the system compliant route;
select one of the identified system compliant routes based on at least one selection criteria, and designating the selected one of the system compliant routes as an active route; and
control the electric power steering system of the vehicle, with the computing device, to maneuver the vehicle along the active route.
